(19) United States
(12) Patent Application Publication
(10) Pub. No.: US 2008/0134047 A1
(43) Pub. Date: Jun. 5, 2008

(54) Method and System For Combining Rating and Navigation/Control Flow Into a Single User Selection

(76) Inventor: Annamalai Pasupathy, Sunnyvale, CA (US)

Correspondence Address: Bruce Hayden, P.O. Box 205, Dillon, CO, 80435, US

(21) Appl. No.: 11/566,213

(22) Filed: Dec. 2, 2006

(51) Int. Cl. G06F 3/00

(52) U.S. Cl. 715/738

(57) ABSTRACT

Users are often presented with navigation buttons, etc. in a hypertext environment like the World Wide Web. These are combined with ratings to provide a convenient, one-click rating system. For example, a Next button may be replaced by three Next buttons, for reporting Like, Indifferent, and Dislike ratings. Clicking the appropriate button would result in tallying the user's rating and navigating to the appropriate destination document. Instead of having a navigation button for each rating, a single navigation button may also be used with clicking on different portions of that button resulting in different ratings being recorded or tallied.

### FIELD OF THE INVENTION

The present invention generally relates to hypertext navigation and, more specifically, to combining the functionality of hypertext navigation, for example over the World Wide Web, with a ratings system.

### BACKGROUND OF THE INVENTION

The World Wide Web (WWW) is becoming ubiquitous. One of the goals of many organizations is to get feedback. For example, when someone buys or sells on eBay, they are requested to rate the corresponding seller's or buyer's performance. eBay users are reminded of this obligation to provide feedback until it is, in fact, provided. Similarly, Microsoft provides chance to report to them whether any automated responses to online help requests are helpful or not. There are numerous other situations where user feedback or ratings are useful in the World Wide Web or similar environments.

One problem that arises is that it invariably takes extra time and keystrokes and/or mouse clicks to provide this feedback. As a result, in many, if not most, cases, wherever possible, users avoid giving it. In situations like that of eBay where it is nearly mandatory, it is given grudgingly.

It would thus be advantageous to provide a mechanism for providing ratings, approval, and/or feedback in an online or electronic environment that did not inconvenience the user.

### BRIEF SUMMARY OF THE INVENTION

Users are often presented with navigation buttons, etc. in a hypertext environment like the World Wide Web. These are combined with ratings to provide a convenient, one-click rating system. For example, a Next button may be replaced by three Next buttons, for reporting Like, Indifferent, and Dislike ratings. Clicking the appropriate button would result in tallying the user's rating and navigating to the appropriate destination document. Instead of having a navigation button for each rating, a single navigation button may also be used with clicking on different portions of that button resulting in different ratings being recorded or tallied.

### BRIEF DESCRIPTION OF THE DRAWINGS

FIG. 1 is an illustration showing using separate buttons for different ratings, in accordance with the present invention;

FIG. 2 is an illustration showing using a single buttons for different ratings, in accordance with the present invention;

FIG. 3 is a diagram illustrating a mapping of three different ratings for the icon or image shown in FIG. 2;

FIG. 4 is a diagram illustrating an example of click-through processing of the Next rating buttons shown in FIG. 1; and

FIG. 5 is a block diagram illustrating a General Purpose Computer.

### DETAILED DESCRIPTION OF THE INVENTION

The present invention provides for button or buttons in electronic media, such as a browser for navigating the World Wide Web, that provide for navigation or control flow and ratings simultaneously. For each navigation/control flow combination, one or more buttons may be used for ratings. For example, in the multiple button case, there might be one rating/navigation button for each rating/navigation combination. In the single button case, one button is provided for each relevant navigation choice, and the relative position where the button was clicked determines the rating provided. The number of possible ratings in such a case is only dependent upon how much granularity is provided to a programmer by the system in which he is working. The content to be rated can be the information displayed in the context, or it can be information supplied as part of navigation/control flow. It may be merchandise purchased online, content viewed, or any other material in which a rating might be desired from a user.

The present invention applies to any electronic medium which has navigation/control flow with buttons, such as: Ok, Cancel, Previous, Next, Back, Forward, etc. that can be combined with user rating information for the contents therein. Hence a user need not specifically be asked to rate the contents. This way, all contents can get rated by the user, without the user taking an extra step to explicitly rating it, and then making a choice on the navigation/control flow. Rather, the invention combines these steps into one. This may also be utilized to force a user to choose a rating before leaving a page, hence guaranteeing rating information from the user.

One of the major theoretical inventions in computers in the last couple decades is that of hypertext linking of documents. Documents are linked together with hyperlinks. The biggest application for this concept is the World Wide Web (WWW), where documents all around the world are linked together with hyperlinks. Clicking on a hyperlink in one document will then direct the software being utilized, typically here a browser, to load up the document being linked to, most often replacing the first document in the browser window. The relationship between documents can be as complex as can be envisioned by its designers. But some of the most common relationships are Previous and Next, where documents are logically provided in a linear fashion. Other, more complex, relationships are also common, and even more will invariably be developed over time. Control flow is somewhat similar, providing such choices as Ok, Abort, and Exit. Henceforth, this disclosure will primarily concentrate on navigation, such as Previous and Next, with the understanding that this is done for illustrative purposes, and that other navigation directions and types of control flow are also within the scope of this invention.

Navigation and control flow in the World Wide Web takes many forms right now. Most often, buttons or other links are provided within a document for this purpose. Web pages are currently composed primarily using Hypertext Markup Language (HTML), which provides a wealth of different mechanisms for this task. Web browsers and other software also often provide this sort of functionality in the form of, for example, buttons, icons, pull-down menus, and hot keys. Henceforth, the term “Button” will be utilized for this purpose, with the understanding that the present invention encompasses actual buttons, plus the myriad of other mechanisms provide a user, either presently, or in the future, for these purposes.

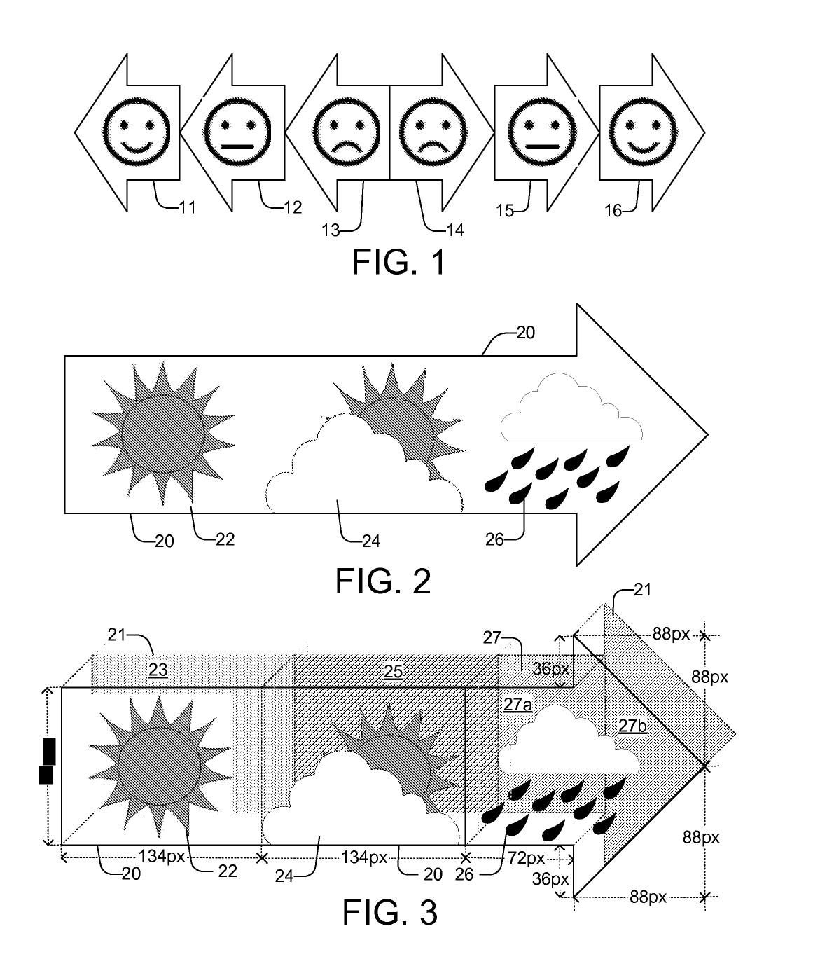

FIG. 1 is an illustration showing using separate buttons for different ratings. Six navigation buttons are shown. There are three pointing to the left, indicating navigating to the previous page, and three to the right, indicating navigating to the next page. The six buttons or icons, listed left to right are:

| Ref# | Navigation | Rating |
|---|---|---|
| 11 | [symbol] Previous | [symbol] Like |
| 12 | [symbol] Previous | [symbol] Indifferent |
| 13 | [symbol] Previous | [symbol] Dislike |
| 14 | [symbol] Next | [symbol] Dislike |
| 15 | [symbol] Next | [symbol] Indifferent |
| 16 | [symbol] Next | [symbol] Like |

The buttons may be in a web page, in a button bar in the browser, or otherwise similarly situated. In one embodiment, the buttons are in a separate frame from the text, allowing the text to scroll while the buttons or icons remain in the same place. In another embodiment, where the buttons are on a web page, for example, at either the top and/or bottom, each button is a separate image, for example rendered through the inclusion of an Image (<IMG>) HTML element. Each such IMG element is then embedded in, or surrounded by an Anchor (<A>) HTML element with its HREF parameter or attribute providing a hyperlink. This mechanism is well known in the prior art and is currently used on millions, if not billions of web pages.

Each of the buttons would in a typical case have a distinct link value in its associated HREF attribute. HREF attributes have a Uniform Resource Identifiers (URI) as their value. URIs include the familiar Universal Resource Locators (URL) used to navigate the World Wide Web. The current definition for URIs is in RFC 2396. URIs include location information and query or search information, which is the information between a “?” and either a “#” or the end of the URI.

One method of implementing the present invention is to utilize the sort of click-through links used by Google and other search engines in their advertising. The initial target of the hyperlink would typically be a site utilized for accumulating ratings. There could be three different web addresses for the three different ratings, or there could be one web address with a parameter indicating the rating, for example, 1=Dislike, 2=Indifferent, and 3=Like. The parameters are typically coded as part of a query or search string. The initial target, after tabulating the rating, would then link to the actual destination (Previous or Next in the present example). This typically happens so quickly in the case of click-through advertising that it is transparent to users. The target URL will typically be coded as another parameter in the query or search string. It should be noted that escape encoding of this URL (or even URI) maybe required.

In an alternate embodiment, Javascript may be utilized instead of, or in addition to, the click-through tallying described above. Instead of specifying a Web address on an HREF attribute for an Anchor (<A>) HTML element, it is also possible to specify that a script, such as Javascript, be executed instead. The Javascript may invoke or access a remote Web site in order to tally the user's preferences, or it may perform the linking itself. Another alternative is to code the target URI as the Anchor HREF attribute, and then specify Javascript as the URI on an ONCLICK or ONDBLCLICK scripting event attached to, for example, the Image (<IMG>). Another alternative is to use an ONCLICK or ONDBLCLICK scripting event attributes assigned to the Image or other HTML element to perform the tallying and linking. Other combinations of Anchor and Javascript are also within the scope of this invention.

FIG. 2 is an illustration showing using a single buttons for different ratings. In this example, a right facing array 24 is an icon or image utilized to link to a Next document. This example shows three different images on the button indicating three different possible ratings. The user votes or provides his rating by clicking on one of these images and his vote is tallied as the Next page is loaded.

This example is similar to the previous example shown in FIG. 1, except that a single button is shown with three different choices on it. Instead of using Anchor elements or ONCLICK or ONDBLCLICK scripting events to perform the tallying and hyperlinking, image maps are typically utilized, with different areas of the map for a button translating into different actions. Maps may be client-side or server-side, and would typically be specified as required as attributes on Image (<IMG>) or Object (<OBJECT>) HTML elements. A client-side map is typically described in HTML utilizing the Map (<MAP>) element, which is a block-level element that can contain other elements, notably here, Area (<AREA>) elements. Area elements can specify, typically in pixels, the shape of an area underlying a button as well as have an HREF attribute with similar functionality to the Anchor element HREF attribute described above. Clicking on the area described by an Area element typically results in the action defined by its HREF, ONCLICK, or ONDBLCLICK attributes. Server-side maps can be utilized in a similar manner, or the server responding to such may perform the tallying or rating recordation function directly, in the process of directing a user to the actual target page or site.

The previous examples have shown giving a user three choices for reviewing something: Dislike; Indifferent (i.e. Don't Care); and Like. Other numbers, fewer and greater than three, of choices are also within the scope of the present invention. In the case of having separate images or icons for each choice/navigation pair can soon become confusing and burdensome as choices are added. However, this is not the case for utilizing a single button, where the place a user clicks on the button is translated into a rating. One mechanism for this is utilizing image Maps, either client-side or server-side. The designer is only limited to how small or narrow he can make the underlying Areas. This is not a limitation however with using either client-side Javascript attached in an ONCLICK or ONDBLCLICK scripting event or with a server-side map. In both cases, it is possible to identify where the cursor is when clicking, and use that information to calculate a rating on a more continuous scale. Thus, if a Next button is 100 pixals long (or tall), and pixels are the metric for determining cursor position (as is currently the case in the Document Object Model (DOM) currently used by browsers to support HTML rendering), the scale can be 100 units long. This information can be determined from the event information provided when an event handler, such as are attached to ONCLICK or ONDBLCLICK scripting events, is invoked. For example, event.clientX returns the horizontal position of the event (in this case, a mouse click), and event. clientY returns the vertical position. Also potentially useful for this purpose are event properties: pageX; pageY; layerX; layerY; screenX; and screenY. The determination of which event attributes are most useful for this purpose is typically dependant upon the structure of the underlying web page. Similar functionality is typically available with server-side maps.

FIG. 3 is a diagram illustrating a mapping of three different ratings for the button shown in FIG. 2. The icon or image 20 has three different ratings: favorable 22, indifferent 24, and unfavorable 26. In HTML, this could be defined through an Image (<IMG>) or an Object (<OBJECT>) element. Logically underneath the Image or Object is a Map 21 that is broken into three Areas, a first one 23 under the Favorable portion of the icon or image 22, a second one 25 under the Indifferent portion of the image or icon 24, and a third one 27 under the Unfavorable portion 26 of the icon or image 20. In the case of a client side mapping, the Map could be implemented a Map (<MAP>) element with three underlying Area (<AREA>) elements, with each Area element corresponding to one of the three possible ratings. Each Area element is a pixal map of the corresponding logically overlaying portion of the image. Thus, the Favorable portion 22 of the image 20 is a rectangle, and, thus, its underlying Area 23 is a rectangle.

Immediately below is a sample table illustrating a mapping of the image 20 shown in FIGS. 2 and 3 into four areas: 23, 25, 27a, and 27b. It uses the sample dimensions shown in this FIG. This is exemplary, and other dimensions and configurations are also within the scope of this invention. Note that the origin for HTML values is the upper left hand corner of an image, screen, document, etc. Thus, the Y values shown are the inverse of what you would expect in conventional mathematics.

| | | | | Upper | | Lower | |
|---|---|---|---|---|---|---|---|
| | | Size | | Left | | Right | |
| Description | # | X | Y | X | Y | X | Y |
| Image | 20 | 428 | 176 | 0 | 0 | 428 | 176 |
| Favorable | 22 | 134 | 104 | 0 | 36 | 134 | 140 |
| Indifferent | 24 | 134 | 104 | 134 | 36 | 268 | 140 |
| Unfavorable | 26 | 72 | 104 | 268 | 36 | 340 | 140 |
| Unfavorable | 26 | 88 | 176 | 340 | 0 | 428 | 176 |

Following is sample HTML code that could implement a client-side area mapping for the image 20 shown in FIGS. 2 and 3, based on the pixal values in the table immediately above and the dimensions shown in this FIG. Note that there are four Areas defined. The displayed image 20 is that of a right pointing arrow, and the Favorable 22 and Indifferent 24 portions of the image are mapped 23, 25 as rectangles (shape=“rect”) on the shaft of the arrow. The Unfavorable portion 26 of the mapping 27 is split between a rectangle defining the remainder of the shaft and the arrowhead itself. This was done for simplicity, since the arrowhead would more likely be mapped as a triangle instead of a rectangle.

<MAP name=“mymap”>
<AREA shape=“rect” coords=“0,36,134,140” HREF=“%GoodURI%”>
<AREA shape=“rect” coords=“134,36,268,140”
HREF=“%MaybeURI%”>
<AREA shape=“rect” coords=“268,36,340,140” HREF=“%BadURI%”>
<AREA shape=“rect” coords=“340,0,428,176” HREF=“%BadURI%”>
</MAP>
<IMAGE src=“myimage.jpg” usemap=“#mymap” width=428 height=176>

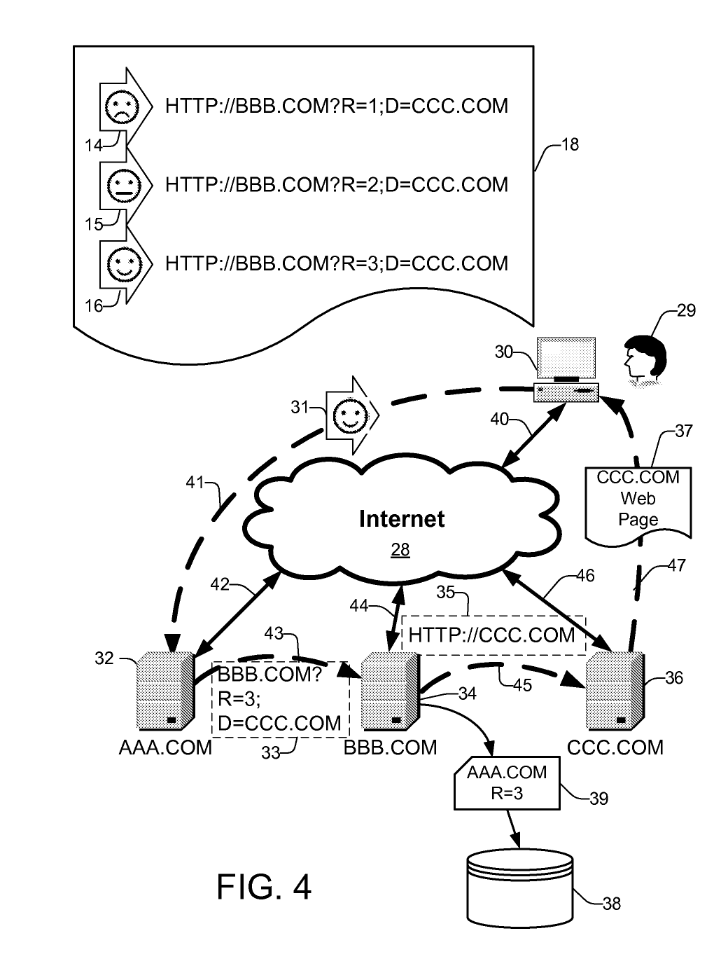

FIG. 4 is a diagram illustrating an example of click-through processing of the Next rating buttons shown in FIG. 1. A user 29 is utilizing a computer 30 to browse the World Wide Web (WWW) over the Internet 28 using a standard Internet browser such as Microsoft Internet Explorer or Mozilla Firefox. Also connected to the Internet 28 are three servers: AAA.COM 32; BBB.COM 34; and CCC.COM 36. The user's computer 30 is connected to the Internet 28 with link 40, AAA.COM 32 with link 42, BBB.COM 34 with link 44, and CCC.COM 36 with link 46. These may be Wireless links, such as IEEE 801.11, Ethernet connections, fiber, or other means known or later developed. Similarly, the connection may be through DSL, cable, fiber, ATM, or other means, currently known, or later developed. The user 29 starts out by browsing a web page 18 on server AAA.COM 32 and is presented with the three Next buttons 14, 15, 16 shown in FIG. 1, with the sample URIs shown below associated with each rating button:

| Ref# | Dir | Rating | URI |
|---|---|---|---|
| 14 | [symbol] | [symbol] Dislike | HTTP//BBB.COM?R=1;D=CCC.COM |
| 15 | [symbol] | [symbol] Indifferent | HTTP//BBB.COM?R=2;D=CCC.COM |
| 16 | [symbol] | [symbol] Like | HTTP//BBB.COM?R=3;D=CCC.COM |

When the user 29 clicks on the Like button 16, this selection is transmitted 31 to the first server, AAA.COM 32, which returns the above URI to the user's computer 30. The browser in the user's computer 30 then issues an HTTP “Get” request 33 to the second server, BBB.COM 34, with a query string of “R=3;D=CCC.COM” attached. The “R=3” indicates that the user's 29 rating was “Like”, and the “D=CCC.COM” indicates that the user's request should be redirected to CCC.COM 36. The second server, BBB.COM 34, tallies the rating for that page, by, for example, writing a record 39 into a database 38. It then strips off the rating and initial address information. Thus, for example, an updated HTTP Get request 37 is formed by converting the URI of “HTTP//BBB.COM?.R=3;D=CCC.COM” in the original HTTP Get request 33 into a URI of “HTTP//BBB.COM. The updated HTTP Get request 35 for the Next page is then forwarded to the selected server, CCC.COM 36, with its source IP address identifying the user's computer 30. In response to this HTTP Get request, the Web page 37 from CCC.COM 36 is transmitted to the user computer 30 and displayed in the browser there. It should be noted that the example shown in FIG. 4 is exemplary, and other methods of implementing similar functionality are within the scope of the present invention.

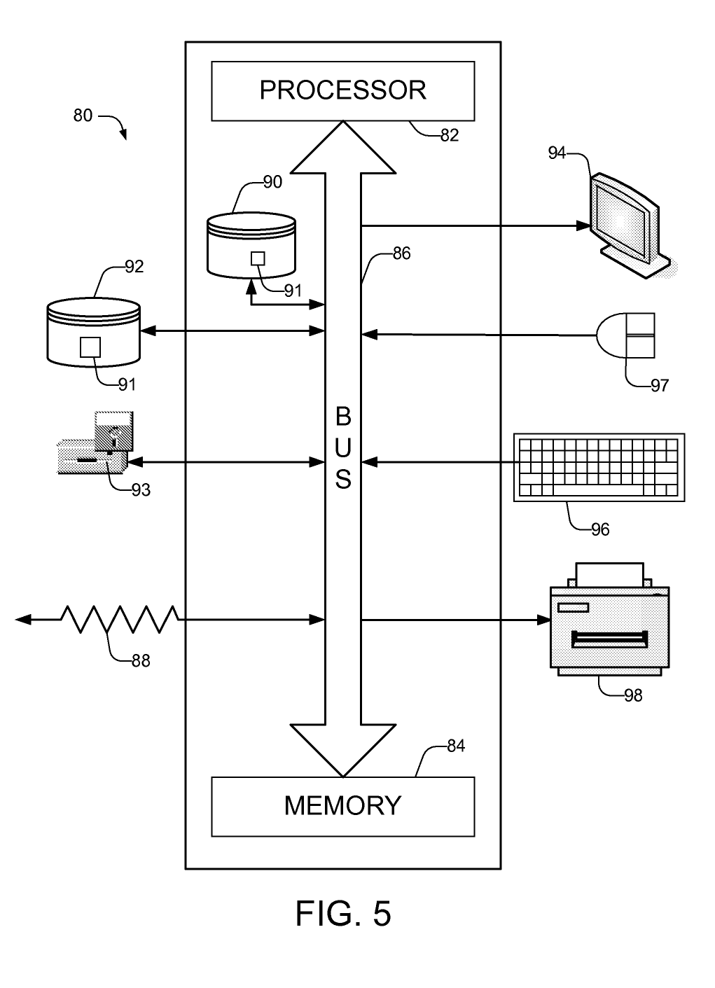

FIG. 5 is a block diagram illustrating a General Purpose Computer 80, such as the computer 30 and servers 32, 34, 36 shown in FIG. 4. The General Purpose Computer 80 has a Computer Processor 82, and Memory 84, connected by a Bus 86. Memory 84 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 90, External Storage 92, output devices such as a monitor 94, input devices such as a keyboard 96 with a mouse 97, and printers 98. Secondary Storage 90 includes machine-readable media such as hard disk drives, magnetic drum, and bubble memory. External Storage 92 includes machine-readable media such as floppy disks 93, removable hard drives, magnetic tape, CD-ROM, and even other computers, possibly connected via a communications line 88. The distinction drawn here between Secondary Storage 90 and External Storage 92 is primarily for convenience in describing the invention. As such, it should be appreciated that there is substantial functional overlap between these elements. Computer software such test programs, operating systems, and user programs can be stored in a Computer Software Storage Medium, such as memory 84, Secondary Storage 90, and External Storage 92. Executable versions of computer software 91, such as browser, operating system, web hosting, and rating software can be read from a Non-Volatile Storage Medium such as External Storage 92, Secondary Storage 90, and Non-Volatile Memory and loaded for execution directly into Volatile Memory, executed directly out of Non-Volatile Memory, or stored on the Secondary Storage 90 prior to loading into Volatile Memory for execution.

Those skilled in the art will recognize that modifications and variations can be made without departing from the spirit of the invention. Therefore, it is intended that this invention encompass all such variations and modifications as fall within the scope of the appended claims.

What is claimed is:

1. A method for providing a rating and performing a navigation/control flow action as a result of a single user selection in a hyperlinked environment, comprising:
providing a first rating as a result of selecting a first portion of a first selection indicator; and
performing the navigation/control flow action as a result of selecting the first portion of the first selection indicator.

2. The method in claim 1 which further comprises:
providing a second rating as a result of selecting a second portion of the first selection indicator; and
performing the navigation/control flow action as a result of selecting the first portion of the first selection indicator.

3. The method in claim 2 which further comprises:
detecting a location selected within the first selection indicator; and
providing a relatively continuous rating that includes the first rating and the second rating through a function applied to the location detected within the first selection indicator.

4. The method in claim 3 wherein:
providing a location selected within the first selection indicator comprises detecting a location of a click of a pointing device.

5. The method in claim 4 wherein:
providing the location of the click of the pointing device utilizes a coordinate of a pixel address of the location selected; and
the function is a linear function that utilizes the coordinate as an independent variable for determining the relatively continuous rating.

6. The method in claim 2 which further comprises:
detecting which one of a plurality of portions of the first selection indicator has been selected comprising:
a first area corresponding to the first rating that provides a hyperlink to the hyperlinked destination; and
a second area corresponding to the second rating that provides a hyperlink to the hyperlinked destination.

7. The method in claim 6 wherein:
the first area and the second area are defined in a client-side map of the first selection.

8. The method in claim 6 wherein:
the first area and the second area are defined in a server-side map of the first selection.

9. The method in claim 1 which further comprises:
providing a second rating as a result of selecting a portion of a second selection indicator; and
performing the navigation/control flow action as a result of selecting the portion of the selection indicator.

10. The method in claim 1 wherein:
the selection indicator is a member of a class consisting of:
a browser button; and
a hyperlinked object in a hypertext document; and
the navigation/control flow action is a member of a class consisting of:
navigating to a previous document; and
navigating to a next document.

11. A system for providing a rating and performing a navigation/control flow action as a result of a single user selection in a hyperlinked environment comprising:
a means of providing a first rating as a result of selecting a first portion of a first selection indicator; and
a means for performing the navigation/control flow action as a result of selecting the first portion of the first selection indicator.

12. The system in claim 11 which further comprises:
a means for providing a second rating as a result of selecting a second portion of the first selection indicator; and
a means for performing the navigation/control flow action as a result of selecting the first portion of the first selection indicator.

13. The system in claim 12 which further comprises:
a means for detecting a location selected within the first selection indicator; and
a means for providing a relatively continuous rating that includes the first rating and the second rating through a function applied to the location detected within the first selection indicator.

14. The system in claim 13 wherein:
the means for providing a location selected within the first selection indicator comprises detecting a location of a click of a pointing device.

15. The system in claim 14 wherein:
the means for providing the location of the click of the pointing device utilizes a coordinate of a pixel address of the location selected; and
the function is a linear function that utilizes the coordinate as an independent variable for determining the relatively continuous rating.

16. The system in claim 12 wherein:
a means for detecting which one of a plurality of portions of the first selection indicator has been selected comprising:
a first area corresponding to the first rating that provides a hyperlink to the navigation/control flow action; and
a second area corresponding to the second rating that provides a hyperlink to the navigation/control flow action.

17. The system in claim 16 wherein:
the first area and the second area are defined in a client-side map of the first selection.

18. The system in claim 16 wherein:
the first area and the second area are defined in a server-side map of the first selection.

19. The system in claim 11 which further comprises:
a means of providing a second rating as a result of selecting a portion of a second selection indicator; and
a means for performing the navigation/control flow action as a result of selecting the portion of the selection indicator.

20. A non-volatile storage medium containing software instructions for providing a rating and performing a navigation/control flow action as a result of a single user selection in a hyperlinked environment, wherein the software instructions comprise:
software instructions for providing a first rating as a result of selecting a first portion of a first selection indicator; and
software instructions for performing the navigation/control flow action as a result of selecting the first portion of the first selection indicator.
